(19) United States
(12) Patent Application Publication
(10) Pub. No.: US 2013/0080336 A1
(43) Pub. Date: Mar. 28, 2013

(54) System for Anonymous Negotiated Sale of Information and Property

(71) Applicants: David Van Wie, Phoenix, AZ (US); Elizabeth Van Wie, Phoenix, AZ (US)

(72) Inventors: David Van Wie, Phoenix, AZ (US); Elizabeth Van Wie, Phoenix, AZ (US)

(73) Assignee: RAT OUT YOUR FRIENDS, LLC, Phoenix, AZ (US)

(21) Appl. No.: 13/247,681

(22) Filed: Sep. 28, 2011

(51) Int. Cl. G06Q 30/06

(52) U.S. Cl. 705/80

(57) ABSTRACT

A system for executing a sale of information between a buyer and an anonymous seller. The buyer transmits a request for information to a website hosted by a server. A seller who has information transmits a response to the website indicating that the seller has relevant information to sell. The buyer and the seller negotiate anonymously through the server using unique, anonymous identifiers to agree to the price and content of the information.

Upon agreement, the buyer deposits the payment in an escrow account. The seller is instructed to disclose information to the buyer through the anonymous relay system. The buyer reviews the information and, if satisfactory, transmits acceptance of it to the server. The server then instructs the escrow account to release the funds to the seller. If the information is not satisfactory, a third-party arbitrator decides whether the funds are released to the seller.

### FIELD OF INVENTION

This invention relates generally to a method for buying information or property from a person who wishes to be anonymous. This invention relates particularly to a computer system that renders at least the seller anonymous and facilitates the payment of money to the seller upon disclosure of the information or provision of the property.

### BACKGROUND

People often have information that is valuable to someone else, but they do not disclose the information because to do so would risk being identified as the informant. Historically police and victims of crimes have dealt with this issue by using anonymous “tip” lines, which offer rewards to informants and follow certain guidelines to ensure their anonymity. These “tip” lines suffer the disadvantage, however, that the informant cannot be certain how much or even that he will be paid for his information once he has disclosed it.

Therefore, it is an object of this invention to provide a system in which an informant can provide information or property anonymously to another, with certainty of the amount that he will be paid.

### SUMMARY OF THE INVENTION

The present invention is a system for executing the sale of information or property between a buyer and an anonymous seller. Alternatively, both buyer and seller can be anonymous. In the preferred embodiment, a victim of a crime seeks information about the crime. Under a unique username, the victim transmits a request for information about the crime to a website hosted by a server. The request is displayed on the website. A person who has information about the crime and wants to sell it transmits a response to the website under a unique user name, indicating that the seller knows something about the crime. The server transmits the response from the anonymous seller to the anonymous victim by transmitting communications through the server. The victim and the seller thus negotiate anonymously through the server's relay system to set a price for the information.

Once the price has been agreed upon, the victim and seller transmit an acknowledgement to the website that they have agreed on the price. The victim deposits funds in an amount equal to the agreed-to price in a monetary escrow account. Once the funds are in escrow, the seller is instructed to disclose the information to the buyer. The seller discloses the information to the buyer through the server's relay system. The victim reviews the information and, if satisfactory, transmits acceptance of it to the website. Upon acceptance or after period of no communication from the victim, the funds are released to the seller, either directly into a seller's bank account or to a third party from which the seller can claim the funds.

If the information is not satisfactory, the victim transmits its dissatisfaction to the website and an arbitration process is implemented. The victim is instructed to submit to the website an explanation of why the information is not satisfactory and the seller is instructed to submit an explanation of why it was satisfactory. A third-party arbitrator decides whether the seller gets its money.

### BRIEF DESCRIPTION OF THE DRAWINGS

FIG. 1 is a schematic view of the system for obtaining information.

FIG. 2 is a flow diagram illustrating the embodiment in which a buyer posts a request for information.

FIG. 3 is a flow diagram illustrating the embodiment in which a seller posts an offer to provide information.

FIG. 4 is a schematic view of the system for obtaining property.

FIG. 5 is a flow diagram illustrating the embodiment in which a buyer posts a request for property.

FIG. 6 is a flow diagram illustrating the embodiment in which a seller posts an offer to provide property.

FIG. 7 illustrates a request for information posted by a buyer.

FIG. 8 illustrates a response posted by a seller to a buyer's request for information.

### DETAILED DESCRIPTION OF THE INVENTION

The present invention is a system for enabling a buyer and a seller to negotiate the sale of information or property and remain anonymous. The system is preferably implemented by a computing device, which comprises at least a processor and memory in communication with the processor. Program instructions are stored on the memory which transforms the physical structure of the memory gates and which, when executed, cause the computer to implement the steps of the method. Multiple computing devices may be in communication with each other to implement the method. The computing devices are in communication with each other across the internet, local or wide-area network, a cellular telephone system, or combination thereof. The buyer and seller communicate with each other via a website hosted by a computing device, preferably a server, which is in communication with other computing devices across the internet, local or wide-area network, a cellular telephone system, or combination thereof. The website is accessible via the internet and displays certain content on a screen such as a computer monitor, tablet or cellular telephone screen. Information is input into the computing devices using any input device, such as a keyboard, touchscreen, or voice recognition system.

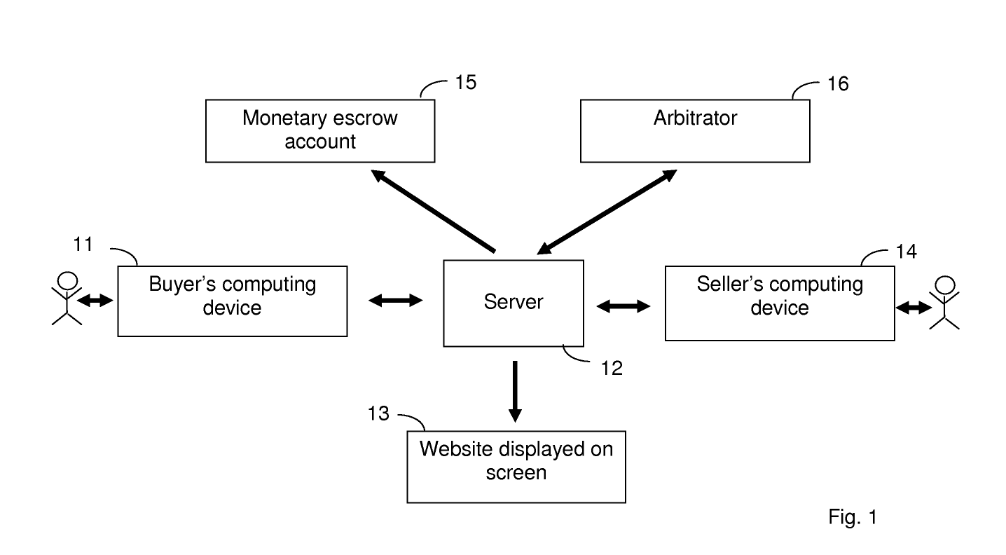

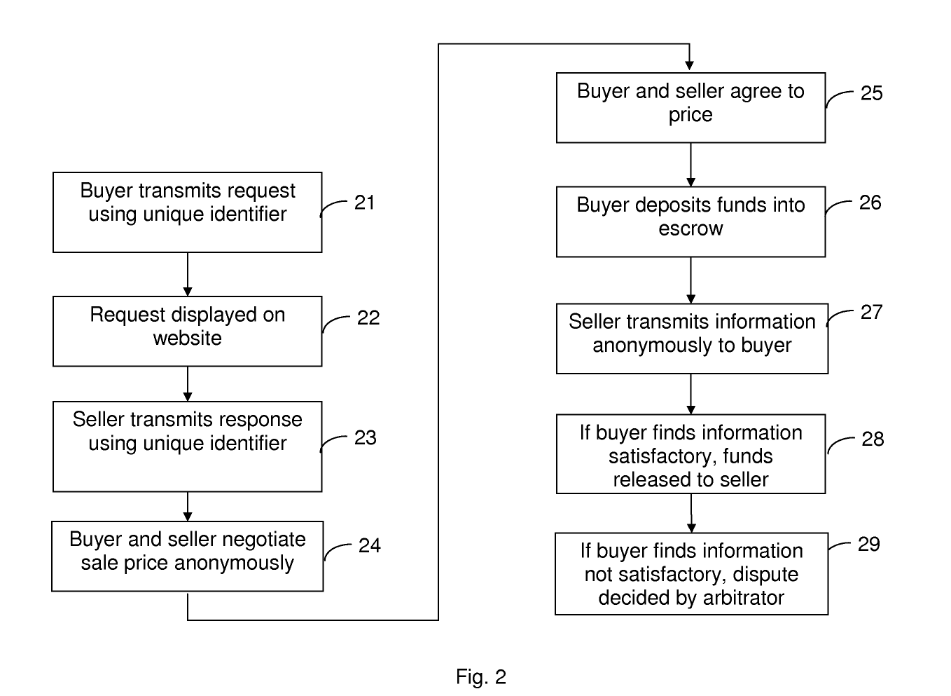

FIG. 1 shows a schematic view of the system for negotiating the sale of information. FIG. 2 is a flow diagram illustrating a preferred embodiment of the method in which both the buyer and seller remain anonymous to each other. In general a buyer, using a unique identifier, uses its computing device 11 to transmit a request 21 for information to a server 12 that hosts a website 13. In the preferred embodiment the unique identifier is chosen by the buyer, such as a username that contains no personal identifying information. The unique identifier is associated with the buyer's real email address so that emails sent under the buyer's username are sent to the buyer's real email address. Alternatively, the server 12 renders the buyer anonymous by giving the buyer a unique identifier that is randomly generated by the server 12 or at least generated in a way that produces an identifier that lacks any personal identifying information of the buyer. The unique identifier is associated with the buyer's real email address. Alternatively, the unique identifier may be an email address from a domain controlled by the server and the server associates that email address with the buyer's real email address so that emails sent to the generated email address are forwarded to the buyer's real email address.

The request is displayed 22 on the website 13, which can be seen by anyone who accesses it. A person who is interested in providing information in response to the request, namely the seller, transmits a response 23 to the website using a unique identifier via the seller's computing device 14. In the preferred embodiment the unique identifier is chosen by the seller, such as a username that contains no personal identifying information. The unique identifier is associated with the seller's real email address so that emails are sent to the seller's real email address. Alternatively, the server 12 renders the seller anonymous, by giving the seller a unique identifier that is randomly generated by the server 12 or at least generated in a way that produces an identifier that lacks any personal identifying information of the seller. The unique identifier is associated with the seller's real email address. Alternatively, the unique identifier is an email address from a domain controlled by the server and the server associates that email address with the seller's real email address so that emails sent to the generated email address are forwarded to the seller's real email address.

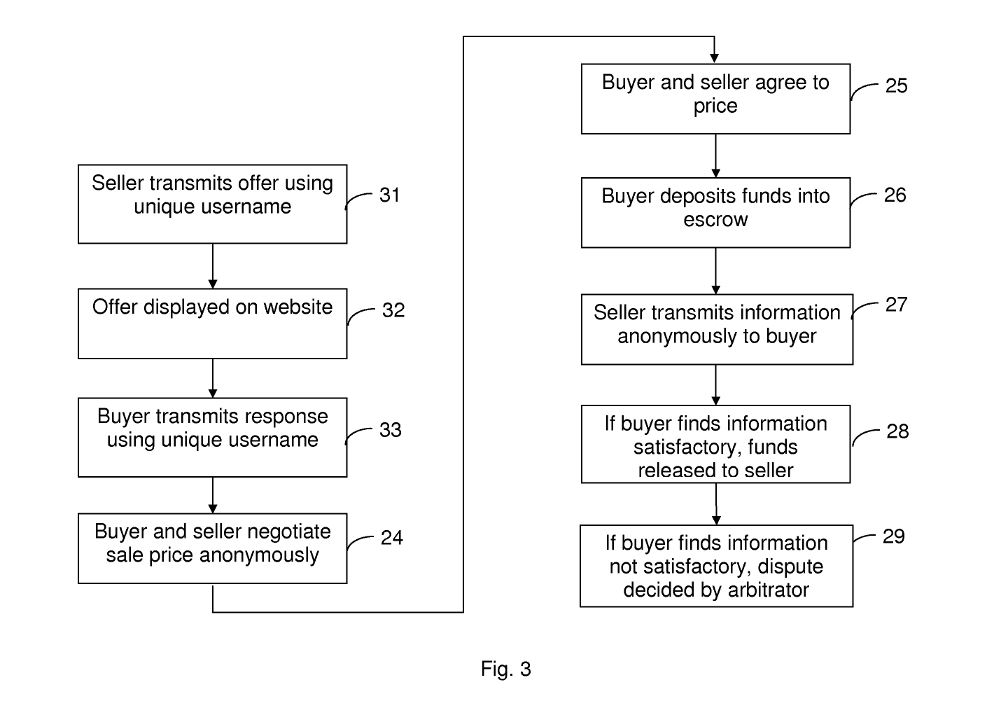

In an alternative embodiment, the seller transmits a general description of information it has for sale on the website. See FIG. 3. The offer is displayed on a website 32. In general a seller, using a unique identifier, uses its computing device 11 to transmit an offer 31 to provide information to a server 12 that hosts a website 13. As above, in the preferred embodiment the unique identifier is chosen by the seller, such as a username that contains no personal identifying information. The unique identifier is associated with the seller's real email address so that emails sent under the seller's username are sent to the seller's real email address. Alternatively, the server 12 renders the seller anonymous, preferably by giving the seller a unique identifier that is randomly generated by the server 12 or at least generated in a way that is unrelated to any personal identifying information of the seller. The unique identifier is an email address from a domain controlled by the server and the server associates that email address with the seller's real email address so that emails sent to the generated email address are forwarded to the seller's real email address. The server 12 displays the offer on the website 13.

A person who is interested in obtaining information offered, namely the buyer, transmits a response 33 to the website using the buyer's computing device 11. In the preferred embodiment the unique identifier is chosen by the buyer, such as a username that contains no personal identifying information. The unique identifier is associated with the buyer's real email address so that emails are sent to the buyer's real email address. Alternatively, the server 12 renders the buyer anonymous, by giving the buyer a unique identifier that is randomly generated by the server 12 or at least generated in a way that is unrelated to any personal identifying information of the seller. The unique identifier may be an email address from a domain controlled by the server and the server associates that email address with the buyer's real email address so that emails sent to the generated email address are forwarded to the buyer's real email address.

The server transmits the buyer's response to the seller, identifying the buyer and seller using only the buyer's and seller's unique identifiers. The buyer and seller continue to communicate with each other via the server using only the unique identifiers to negotiate 24 the price and content of the information to be provided. Because the buyer and seller have no information about the other except the unique identifier, they remain anonymous to each other.

Once the buyer and seller agree to the price 25, the buyer is instructed to deposit funds into a monetary escrow account 15. The buyer deposits funds into escrow 26 and, once the escrow deposit has been confirmed, the seller is notified that the funds are in escrow and is instructed to disclose the information to the buyer as they agreed. The seller transmits 27 the information to the buyer via the server, again using only the buyer's and seller's unique identifiers. If the buyer finds the information satisfactory, the buyer indicates its acceptance on the website, and in turn the seller is notified and the escrow account is instructed to release funds 28 to the seller. If the buyer fails to provide notice that the information is acceptable after a given period of time, the information is deemed satisfactory, the seller is notified and the escrow funds are released 28 to the seller.

If the information is not satisfactory, the buyer transmits its dissatisfaction to the website and a dispute resolution process is implemented. The buyer is instructed to submit to the website an explanation of why the information is not satisfactory and the seller is instructed to submit an explanation of why it was satisfactory. A third-party arbitrator decides 29 whether the seller gets its money.

Common types of information to be sold include facts and opinions, communicated by text and photograph. Any category of information can be the subject of the request, such as theft, shoplifting, software piracy, vandalism, pranks, dead beat dads, identity fraud, laziness, and politics. As used herein, “information” includes physical things unless expressly stated otherwise.

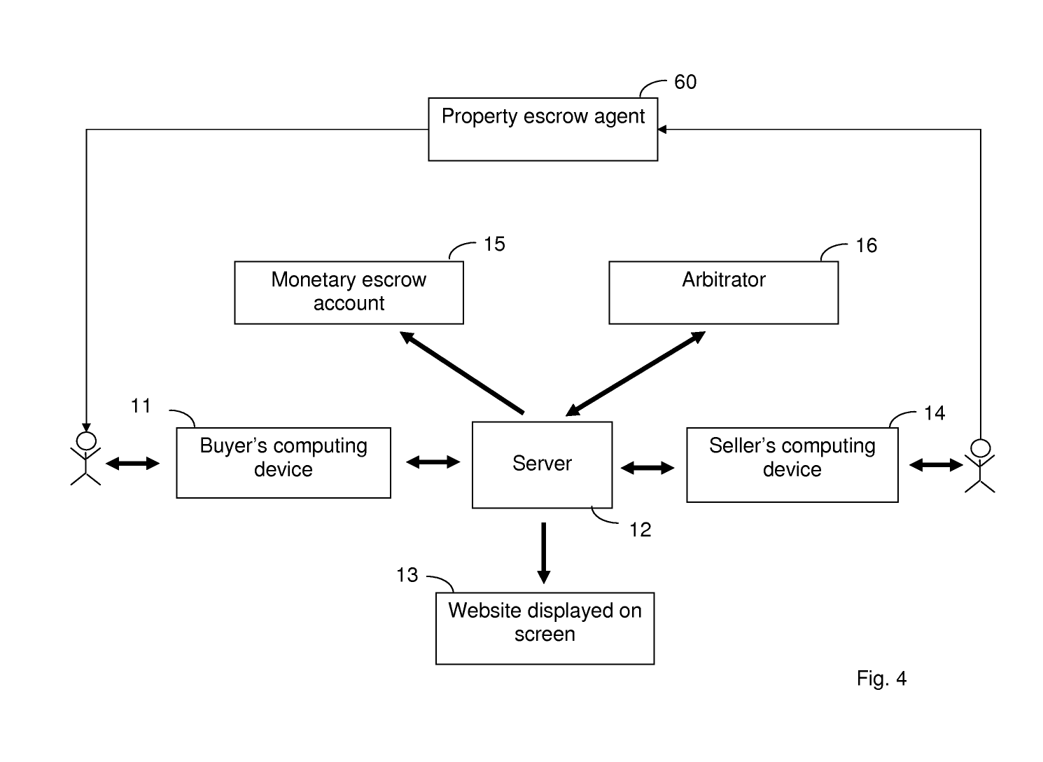

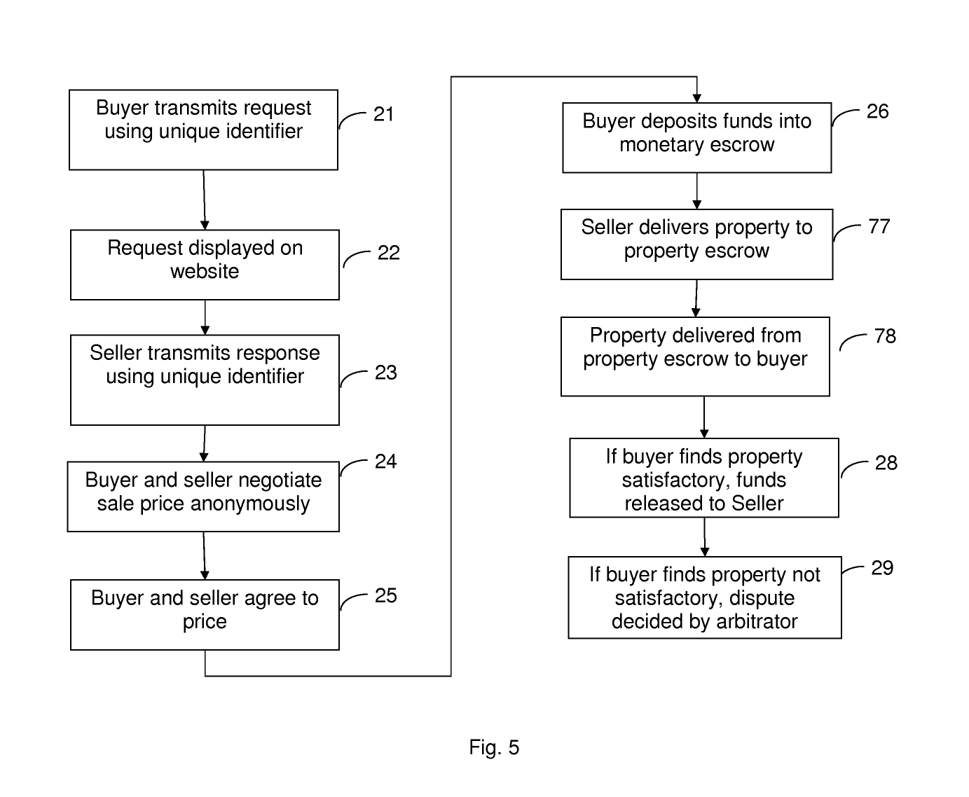

For example, in another embodiment, the subject of the negotiation is physical property, such as jewelry or a vehicle. FIG. 4 shows a schematic view of the system for negotiating the sale of property. FIG. 5 is a flow diagram illustrating a preferred embodiment of the method in which both the buyer and seller remain anonymous to each other. The system of negotiating the sale of property is substantially similar to the system of negotiating the sale of information. In general a buyer, using a unique identifier, uses its computing device 11 to transmit a request 21 for property to a server 12 that hosts a website 13. The unique identifier is chosen by the buyer, such as a username that contains no personal identifying information and the unique identifier is associated with the buyer's real email address so that emails sent under the buyer's username are sent to the buyer's real email address. Alternatively, the server 12 renders the buyer anonymous by giving the buyer a unique identifier that is randomly generated by the server 12 or at least generated in a way that produces an identifier that lacks any personal identifying information of the buyer. The unique identifier is associated with the buyer's real email address, but alternatively the unique identifier may be an email address from a domain controlled by the server and the server associates that email address with the buyer's real email address so that emails sent to the generated email address are forwarded to the buyer's real email address.

The request is displayed 22 on the website 13. A person who is interested in providing property in response to the request, namely the seller, transmits a response 23 to the website using a unique identifier via the seller's computing device 14. The unique identifier is chosen by the seller, such as a username that contains no personal identifying information. The unique identifier is associated with the seller's real email address so that emails are sent to the seller's real email address. Alternatively, the server 12 renders the seller anonymous, by giving the seller a unique identifier that is randomly generated by the server 12 or at least generated in a way that produces an identifier that lacks any personal identifying information of the seller. The unique identifier is associated with the buyer's real email address but, alternatively, the unique identifier may be an email address from a domain controlled by the server and the server associates that email address with the seller's real email address so that emails sent to the generated email address are forwarded to the seller's real email address.

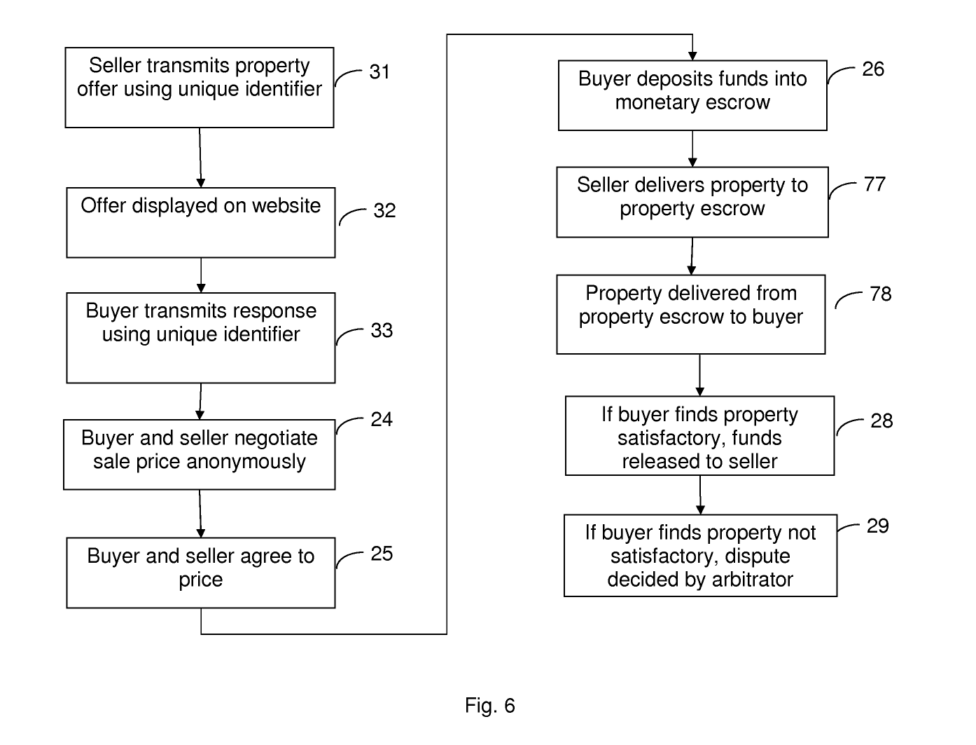

In an alternative embodiment, the seller posts a general description of property it has for sale on the website. See FIG. 6. The seller, using a unique identifier, uses its computing device 11 to transmit an offer 31 to provide property to a server 12 that hosts a website 13. As explained above, the unique identifier is chosen by the seller and is associated with the seller's real email address so that emails sent under the seller's username are sent to the seller's real email address. Alternatively, the server 12 renders the seller anonymous, preferably by giving the seller a unique identifier that is randomly generated by the server 12 or at least generated in a way that is unrelated to any personal identifying information of the seller. The unique identifier is an email address from a domain controlled by the server and the server associates that email address with the seller's real email address so that emails sent to the generated email address are forwarded to the seller's real email address. The server 12 displays the offer on the website 13.

A person who is interested in obtaining property offered, namely the buyer, transmits a response 33 to the server using the buyer's computing device 11. Again, the unique identifier is chosen by the buyer and is associated with the buyer's real email address so that emails are sent to the buyer's real email address. Alternatively, the server renders the buyer anonymous, by giving the buyer a unique identifier that is randomly generated by the server 12 or at least generated in a way that is unrelated to any personal identifying information of the seller. The unique identifier may be an email address from a domain controlled by the server and the server associates that email address with the buyer's real email address so that emails sent to the generated email address are forwarded to the buyer's real email address.

The server transmits the buyer's response to the seller, identifying the buyer and seller using only the buyer's and seller's unique identifiers. The buyer and seller continue to communicate with each other via the server using only the unique identifiers to negotiate 24 the price and content of the property to be provided. Because the Buyer and seller have no information about the other except the unique identifier, they remain anonymous to each other.

Once the buyer and seller agree to the price 25, the buyer is instructed to deposit funds into a monetary escrow account. The buyer deposits funds into escrow 26 and, once the escrow deposit has been confirmed, the seller is notified that the funds are in escrow and is instructed to deliver the property to a third party property escrow agent 60 at a given physical address, preferably the entity that controls the website or the monetary escrow account. The seller delivers, or has the property delivered, to the property escrow agent 77. Once the property escrow agent receives the property, it sends an email to the buyer notifying it that the property is available and requesting a delivery address. The property escrow agent then delivers the property 78 to the delivery address set forth by the buyer. If the buyer finds the property satisfactory, the buyer indicates its acceptance on the website, which in turn notifies the seller and instructs the escrow funds to be released 28 to the seller. If the buyer fails to provide notice that the information is acceptable after a given period of time, the property is deemed satisfactory, the seller is notified and the escrow funds are released 28 to the seller.

As explained above, if the property is not satisfactory, the buyer transmits its dissatisfaction to the website and a dispute resolution process is implemented. The buyer is instructed to submit to the website an explanation of why the property is not satisfactory and the seller is instructed to submit an explanation of why it was satisfactory. A third-party arbitrator decides 29 whether the seller gets its money.

Preferably the delivery costs are paid by the seller and buyer. For example, the seller pays for shipping to the property escrow agent, which may ship the property COD to the buyer. Or, when notifying the buyer that the property is ready for delivery, the property escrow agent can also request that the buyer pre-pay for delivery costs by depositing additional funds into the monetary escrow account.

The monetary escrow account 15 is preferably a bank account that is in communication with the server so that the buyer's deposit can be made through the website. Buyers can deposit money to the monetary escrow account in any way money can be transferred online, such as by credit card payment, debit card payment, wire transfer, ACH payments, and Pay Pal®. Alternatively, the buyer can deposit money to the monetary escrow account in any way money can be transferred offline, such as by cash, money order or paper check. The identity of the buyer remains anonymous because the seller cannot view the deposit into the monetary escrow account. Money transfer companies that enable money to be picked up using a passcode or other unique identifier that does not require that the person picking up the money to disclose his or her identity, such as Western Union® and MoneyGram® provide an additional layer of anonymity for the seller. In the preferred embodiment, the server also provides the seller another unique identifier that the seller uses as identification to claim the funds anonymously from a money transfer company. Non-cash payments would need to be physically transferred between the buyer and seller and, as a consequence, these transactions may cause buyers and lose their anonymity, unless the payments are brokered by third parties. For example, the property escrow agent could transfer the non-cash payment.

Deals can be negotiated using alternative communication systems, preferably within a closed system. For example the website may also provide an email program so that the buyer and seller can log into the email program hosted by the server using their respective username and password and manipulate emails within the server's domain. Users of the website are subject to certain terms of use that inform them and obligate them to the conditions of the closed system and violators can be denied participation. A closed system enables the library of requests to be easily searchable by keyword, subject, date of occurrence, geographical location, employer or other parameter.

The buyer and seller are identified on the website only by their unique anonymous identifiers. Communications between the buyer and seller are conducted through the server to ensure anonymity. The communications are preferably conducted by email using email addresses that are associated with the buyer's and seller's anonymous unique identifiers. Alternatively, communications can be conducted by SMS text messaging or other means using the buyer's and seller's real phone numbers that are associated with the buyer's and seller's anonymous unique identifiers. Because the buyer and seller have no information about the other except the unique identifier, they remain anonymous to each other. The server acts as an anonymizing relay system and, optionally, to anonymize the buyer and seller.

The method described above enables the buyer and seller to remain anonymous to each other. If desired, the server can request that the buyer or the seller, or both, provide personal identifying information to the server, which is recorded but not disclosed to the counterparty in the negotiation. Having such personal identifying information may be useful for enforcing the terms of use of the website or helping prevent fraud in the escrow deposit or payout. Conversely, after the transaction is complete, the server may be purged of the unique identifiers and email addresses associated with them so the buyers and sellers remain anonymous, even after forensic evaluation.

In some instances, however, the buyer may not care to remain anonymous and instead may find it advantageous to make its identity known. For example, if the buyer is a person or entity offering a reward for information leading to the arrest or conviction of a perpetrator of a crime, it may be advantageous for the buyer to identify itself to improve its credibility with potential sellers. In this way, the present method improves on the existing system of tip lines because it enables the informant to be certain how much he will be paid for his information once he has disclosed it.

The system can be used to generate revenue in a number of ways, such as by charging the buyer a periodic or per-item fee to post a request, charging the seller to respond to the request, by taking a percentage of the seller's reward, or by tacking on a fee to the seller's payout. Or, for a fee, a business can set up an account on the website that will provide automatic notification if that business's name comes up in a request or response. Not only does this service allow businesses to keep track of possible crimes at the workplace, it also serves as a deterrent. Employees and clients can be put on notice that the business participates in the present system to pursue poorly performing employees or aggressively catch criminals and possibly prosecute.

The system can be used to negotiate the sale of many types of information and property, some of which are shown in the following examples.

### Example 1

### Victim Seeks Information about a Crime

A victim of a crime seeks information about the crime. The victim transmits a request for information about the crime to a website hosted by a server. The server renders the victim anonymous by giving the victim a unique identifier and displays the request on the website. A person who has information about the crime and wants to sell it transmits a response to the website indicating that he or she knows something about the crime. The server renders the informant anonymous by giving it its own unique identifier and transmits the response from the now-anonymous informant to the anonymous victim. The victim and the informant negotiate anonymously through the server to set a price for the information.

Once the price has been agreed upon, the victim and informant transmit an acknowledgement to the website that they have agreed on the price. The victim deposits funds in an amount equal to the agreed-to price in a monetary escrow account. The server notifies the informant that the funds are in escrow and instructs the informant to disclose the information to the victim through the anonymous relay system using its anonymous unique identifier. The victim reviews the information and finds it satisfactory. The victim has no further communication with the seller the lack of communication after 14 days constitutes acceptance, so the server then instructs the escrow account to release the funds to the informant, either directly or to a third party from which the informant can claim the funds.

Other informants may have information regarding the crime, too. Each potential informant can respond to the victim through the anonymous relay system using his or her own anonymous unique identifier. The victim can choose which, if any, of the responses to respond to and accept. Once the victim has the information it needs, it removes the information request from the website.

The anonymity is particularly beneficial to the informants, because it prevents them from being identified by the criminals and thus avoids retribution. It also protects their identity from the victim, police and prosecutors, which avoids having to provide evidence or testimony for any investigation or trial for the crime.

### Example 2

### Victim Seeks Information about a Crime

In a preferred embodiment, a buyer and a seller each have a personal computer in communication with the World Wide Web. The buyer is a victim of a crime and wants information about the perpetrator. The buyer registers for an account at a website, www.ratoutyourfriends.com, displayed by a server, by typing in his email address into the website and typing in a user name. To retain anonymity, the buyer does not use his real name or a personally-identifiable name for his user name. Instead, the buyer enters an arbitrary user name he makes up. As part of the registration, the buyer clicks on a button that indicates that he agrees to certain Terms of Use of the website. The website gives the buyer an arbitrary email address within the domain of the server, in this case buyer123@ratoutyourfriends.com, and associates it with the buyer's real email address.

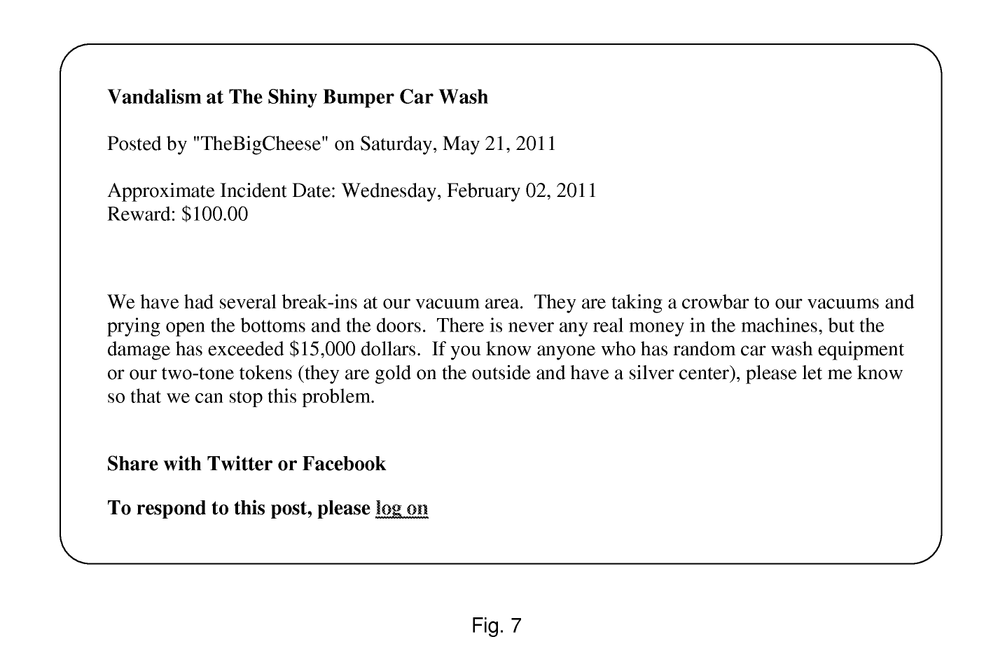

The buyer then types in the information request about the crime for posting on the website, as shown in FIG. 7. The request contains a title of the incident, namely “Vandalism at The Shiny Bumper Car Wash,” an approximate date that the crime occurred, a description of the crime, and that the buyer will pay $100 for certain information, namely “anyone who has random car wash equipment or our two-tone tokens.” The request is posted by the server showing only the buyer's user name, namely “The Big Cheese.” The request may be shared by social media such as Twitter® or Facebook®, but responses must be made through the server. The posting is added to the library of other requests on the website.

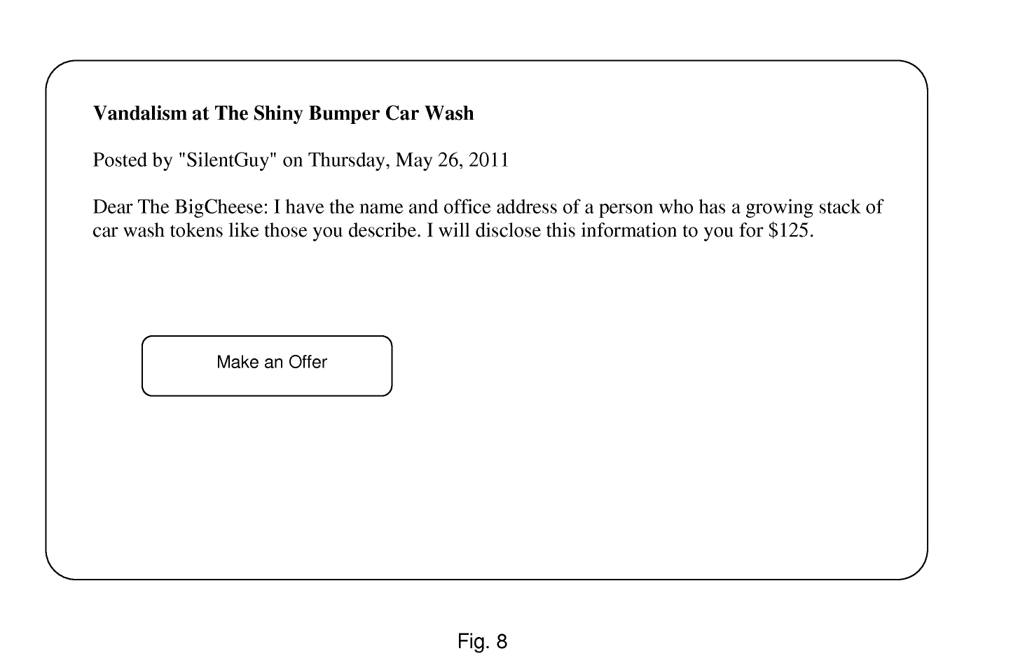

A potential seller searches the library of postings to see if a buyer wants to buy its information. In this example, the potential seller's friend has a growing stack of car wash tokens on his desk at work, which the potential seller always thought was a bit odd, since his friend didn't own a car. The seller registers for an account at a website, www.ratoutyourfriends.com, displayed by a server, by typing in his email address into the website and typing in a user name, “SilentGuy.” To retain anonymity, the seller does not use his real name or a personally-identifiable name for his user name. Instead, the seller enters an arbitrary user name he makes up. As part of the registration, the seller clicks on a button that indicates that he agrees to certain Terms of Use of the website. The website gives the seller an arbitrary email address within the domain of the server, in this case seller456@ratoutyourfriends.com, and associates it with the seller's real email address. The seller types a response stating that he will disclose the name and office address of his friend who has growing stack of tokens for $125, as shown in FIG. 8. The seller and clicks on a link on the website labeled “Make an Offer” to send the response. The server forwards the response to the buyer using the anonymizing relay system, in which the email is sent to buyer123@ ratoutyourfriends.com, which is then forwarded to the buyer's real email address where the buyer views the response.

The buyer can accept, reject, or negotiate the price and content of the information to be disclosed, and in this case accepts the seller's counteroffer of $125 because not only is the buyer going to get the name of the person with the growing stack of tokens, but also his office address.

The decision made to accept the counteroffer, the buyer clicks on a link on the website labeled “accept” (not shown) to notify the server that a deal has been reached. The server, using the username as the link to the real email addresses, sends an email to seller letting him know that a deal has been reached and explaining the next steps, specifically instructing the buyer to make a deposit in the escrow account for the $125. The seller is copied on the email at the seller's arbitrary email address so that he can stay informed of the progress of the transaction. The buyer pays the amount by clicking on a link on the website labeled “pay now” (not shown) and follows the instructions for electronic payment by credit card. Once the funds have been received into the escrow account, the server sends an email to the seller at his arbitrary email address notifying it that it is to disclose the information to the buyer.

The seller sends an email with the information to the buyer using the anonymizing relay system. The email says that Larry Swiper is the person with the stack of tokens and his office is at 123 Apple Blvd, in Phoenix, Ariz.

Per the Terms of Use, the buyer has 14 days to review the information and determine whether it meets the deal terms, i.e. whether it is valid or substantively what the seller promised to disclose. In this case, the buyer decides the information is satisfactory and clicks on “Done Deal” link on the website. The server sends an email to the seller at its arbitrary email address with a passcode for the seller to use to pick up the funds at Western Union.® The buyer is not copied on that email. If the buyer had disputed that the information was what the seller said he would disclose or felt that the information was false, the seller would not have been paid. If the seller insisted his information was in fact valid by, for example, sending an email to dispute@ratoutyourfriends.com, then per the Terms of Use, the parties would have utilized a third party arbitrator to decide the dispute.

### Example 3

### Journalist Posts Request for Compromising Photos

A tabloid journalist seeks compromising photos of a certain celebrity. The journalist enters a username and posts a request for such photos to a website hosted by a server. The server displays the request on the website. A photographer who has photos of the celebrity and wants to sell them searches the website for a buyer's request for photos of the celebrity he has photographs of. The photographer enters a unique username and transmits a response to the website indicating that the photographer has a photo of the journalist's desired celebrity. The journalist and the photographer negotiate anonymously through the server to set a price for the photo.

Once the price has been agreed upon, the journalist and photographer each transmit an acknowledgement to the website that they have agreed on the price. The journalist deposits funds in an amount equal to the agreed-to price in a monetary escrow account. The server notifies the photographer that the funds are in escrow and instructs the photographer to send the photo to the journalist through the anonymous relay system using its anonymous unique identifier. The journalist reviews the photo and, because it is satisfactory, transmits acceptance of it to the server. The server then instructs the escrow account to release the funds to the photographer, either directly or to a third party from which the photographer can claim the funds.

If the photographer has other photos it thinks would be of interest to the journalist, the photographer can contact the journalist again via the website using the journalist's unique, anonymous username.

The anonymity is beneficial to both the journalist and the photographers. The anonymity for the journalist prevents the photographers from charging higher prices it might charge if it knew the journalist worked for a prominent media outlet. The anonymity for the photographer prevents the photographer from incurring the wrath of the celebrity.

### Example 4

### Employer Posts on-Going Request

An employer seeks information about employees who do not comply with their job duties. The employer posts to a website a request for information about its employees' dereliction of duties. The posting may take the form of an on-going request for such disclosures in order to maintain quality, performance, and productivity over time. The posting may also be for a given price, not subject to negotiation with the seller who responds.

The employer would not be anonymous, because its request is specific to information about its employees. The request is displayed on the website. A seller who has information about an employee can disclose the information to the employer anonymously. The seller chooses a unique username that he creates that has no personal identifying information and transmits the anonymous response to the employer via the website email system. The employer and the seller communicate anonymously through the server to agree on the characteristics of the information to be provided.

For example, the employer may have a posting that says it will pay $100 for each disclosure of information about any employee's behavior that violates the company's work rules. The employer deposits money into a monetary escrow account in an amount that would cover multiple purchases. A seller can contact the employer anonymously through the website and offer that he knows a production line worker who takes naps in supply closets during work hours. The employer will agree that that qualifies as a satisfactory disclosure and agrees to pay the seller when the seller provides the employee's name and details of the naps. The employer allocates $100 of the money in its monetary escrow account for the seller. The seller is notified that the funds are in escrow and is instructed to send the derelict employee's name and nap details to the employer through the website's anonymizing relay system. The employer reviews the information and, being satisfied, transmits acceptance of it to the server. The server then instructs the escrow account to release the funds to the seller and provides a Money Transfer Control Number (MTCN) that the seller uses as proof of ownership to claim the funds from Western Union®.

### Example 5

### Informant Posts Notice

An informant sends a notice to the website that he witnessed the vandalism of the convenience store at Main Street and Central Avenue on July 22, and that he is willing to disclose what he knows in return for payment. The server hosting the website renders the informant anonymous by giving the informant a unique identifier and displays the notice on the website. A claims adjuster from the insurance company that insured the convenience store against vandalism transmits a response to the website indicating that he is interested in obtaining information about the vandalism. The claims adjustor does not choose to be anonymous. The server transmits the claim adjuster's response to the anonymous informant. The claims adjuster and the informant negotiate anonymously through the server to set a price for the information the informant can provide about the vandalism.

Once the price and content of the information has been agreed upon, the claims adjuster and the informant each transmit an acknowledgement to the website that they have agreed on the price. The claims adjuster deposits funds in an amount equal to the agreed-to price in an escrow account. The server notifies the informant that the funds are in escrow and instructs the informant to send the information to the claims adjuster through the anonymous relay system using its anonymous unique identifier. The claims adjuster reviews the information and, if satisfactory, transmits acceptance of it to the server. The server then instructs the escrow account to release the funds to the informant.

The informant's anonymity is beneficial to the informant because it prevents the informant from retribution from the vandals and assuages some guilt of being an informant.

### Example 6

### Seller Offers Property to Sell

A seller has a gold necklace to sell. Using a unique username, seller posts an offer to sell the necklace on a website, which includes a photo of the necklace. The buyer sees the photo and makes an offer under a unique username to buy the necklace for $100 using the “Make an Offer” button. The buyer and seller to communicate using the “Make an Offer” button repeatedly to transmit offers and counteroffers under their unique anonymous usernames, keeping them both anonymous, until they agree on a price for the necklace. The buyer and seller finally agree on a price and the buyer is sent an email with instructions to send in money to start the escrow process. The buyer sends a money order to the monetary escrow agent. Once funds are received buyer and seller are emailed and seller is instructed to pay for shipping the property to a property escrow agent at 123 Main Street, Miss. 457, Sioux City, Iowa 59001. Once the property escrow agent receives the property, it sends an email to buyer asking for buyer to pay for the shipping charges to buyer and requests an address to whip the property to. The property escrow agent then ships property to buyer. The buyer responds to the website that he is satisfied with the necklace and the funds are then released to seller via Western Union using a passcode.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiments disclosed, but that the invention will include all embodiments falling within the scope of the appended claims.

1. A method for anonymously negotiating the sale of information comprising:
a. receiving a request for information from a buyer wherein the buyer is using an anonymous buyer unique identifier;
b. displaying the request from the buyer;
c. receiving a response from a seller to the request for information, wherein the seller is using an anonymous seller unique identifier;
d. relaying one or more emails between the buyer and seller, identifying the buyer and seller using only the buyer unique identifier and seller unique identifier;
e. receiving an indication that the buyer and seller have agreed to a price;
f. receiving an indication from a monetary escrow account that funds in an amount equivalent to the agreed-to price are in the monetary escrow account;
g. transmitting the information to the buyer; and
h. instructing the escrow account to release the funds to the seller in an amount equivalent to agreed-to price.

2. The method of claim 1 further comprising the buyer choosing its anonymous buyer unique identifier and the seller choosing its anonymous seller unique identifier.

3. The method of claim 1 further comprising:
a. rendering the buyer anonymous by generating the anonymous buyer unique identifier and providing it to the buyer; and
b. rendering the seller anonymous by generating the anonymous seller unique identifier and providing it to the seller.

4. The method of claim 1 further comprising instructing the buyer to deposit funds in an amount equivalent to the agreed-to price into a monetary escrow account.

5. The method of claim 1 further comprising receiving an indication from the buyer that the information is satisfactory.

6. The method of claim 1 further comprising:
a. receiving an indication from the buyer that the information is not satisfactory;
b. instructing the buyer to submit an explanation of why the information is not satisfactory and the seller to submit an explanation of why it was satisfactory; and
c. rendering a decision that the funds in the monetary escrow account are to be released to the seller.

7. The method of claim 1 further comprising providing a third unique identifier to the seller to be used to claim the funds.

8. The method of claim 1 wherein the information is physical property.

9. A method for anonymously negotiating the sale of information comprising:
a. a victim, using an input device, transmitting to a server a request for information about a crime, wherein the victim transmits the request using an anonymous victim unique identifier;
b. the server displaying on a website the request from the victim along with the victim unique identifier;
c. a seller, using an input device, transmitting a response to the request for information to the server, wherein the seller transmits the request using an anonymous seller unique identifier;
d. the server relaying one or more emails between the victim and seller, identifying the buyer and seller using only the buyer unique identifier and seller unique identifier;
e. the server receiving an indication that the victim and seller have agreed to a price of the information;
f. the server receiving an indication from an escrow account that funds in an amount equivalent to the agreed-to price have been deposited in the escrow account;
g. the server transmitting the disclosed information to the victim; and
h. the server instructing the escrow account to release the funds in an amount equivalent to agreed-to price to the seller.

10. The method of claim 9 further comprising:
a. the server rendering the victim anonymous by generating the anonymous victim unique identifier and providing it to the victim; and
b. the server rendering the seller anonymous by generating the anonymous seller unique identifier and providing it to the seller.

11. The method of claim 9 further comprising instructing the buyer to deposit funds in an amount equivalent to the agreed-to price into a monetary escrow account.

12. The method of claim 9 further comprising receiving an indication from the buyer that the information is satisfactory.

13. The method of claim 9 further comprising:
a. receiving an indication from the buyer that the information is not satisfactory;
b. instructing the buyer to submit an explanation of why the information is not satisfactory and the seller to submit an explanation of why it was satisfactory; and
c. rendering a decision that the funds in the monetary escrow account are released to the seller.

14. The method of claim 9 wherein the information is physical property.

15. A method for anonymously negotiating the sale of information comprising:
a. a server receiving a description of information for sale from a seller using an anonymous seller unique identifier;
b. the server displaying the description of information on a website;
c. the server receiving a response to the description of information for sale from a buyer using an anonymous buyer unique identifier;
d. the server relaying one or more emails between the buyer and seller, identifying the buyer and seller using only the buyer unique identifier and seller unique identifier;
e. the server receiving an indication that the buyer and seller have agreed to a price of the information;
f. the server receiving an indication from an escrow account that funds in an amount equivalent to the agreed-to price are in the escrow account for the seller;
g. the server instructing the seller to transmit the information to the server;
h. the server transmitting the disclosed information to the buyer;
i. the server receiving an indication that the information is satisfactory; and
j. the server instructing the escrow account to release the funds in an amount equivalent to the agreed-to price.

16. The method of claim 15 further comprising the server instructing the buyer to deposit funds in an amount equivalent to the agreed-to price into a monetary escrow account.

17. The method of claim 15 wherein the information is physical property.

18. A method for anonymously negotiating the sale of property comprising:
a. receiving a request for physical property from a buyer wherein the buyer transmits the request using an anonymous buyer unique identifier;
b. displaying the request from the buyer;
c. receiving a response from a seller to the request for physical property, wherein the seller transmits the request using an anonymous seller unique identifier;
d. relaying one or more emails between the buyer and seller, identifying the buyer and seller using only the buyer unique identifier and seller unique identifier;
e. receiving an indication that the buyer and seller have agreed to a price;
f. instructing the buyer to deposit funds in an amount equivalent to the agreed-to price into a monetary escrow account;
g. receiving an indication from the monetary escrow account that funds in an amount equivalent to the agreed-to price are in the monetary escrow account;
h. instructing the seller to deliver the property to a property escrow agent;
i. notifying the buyer that the property is ready to be delivered and requesting a delivery address;
j. delivering the property to the buyer;
k. receiving an indication from the buyer that the property is satisfactory; and
l. instructing the monetary escrow account to release the funds to the seller in an amount equivalent to agreed-to price.
